(19) United States
(12) Patent Application Publication
(10) Pub. No.: US 2026/0270175 A1
(43) Pub. Date: Sep. 10, 2026

(54) FAULT PROCESSING

(71) Applicant: TENCENT TECHNOLOGY (SHENZHEN) COMPANY LIMITED, Shenzhen (CN)

(72) Inventors: Bing XU, Shenzhen (CN); Yuan CHEN, Shenzhen (CN); Junliang ZENG, Shenzhen (CN)

(73) Assignee: TENCENT TECHNOLOGY (SHENZHEN) COMPANY LIMITED, Shenzhen (CN)

(21) Appl. No.: 19/666,822

(22) Filed: May 4, 2026

Related U.S. Application Data
(63) Continuation of application No. PCT/CN2024/137532, filed on Dec. 6, 2024.

(30) Foreign Application Priority Data
Jan. 24, 2024 (CN) 202410101673.X

(51) Int. Cl. H04L 43/0817; H04L 41/0631; H04L 67/10

(52) U.S. Cl. CPC H04L 43/0817; H04L 41/0631; H04L 67/10

(57) ABSTRACT

Based on a distributed cloud that includes a central node and one or more edge nodes, a determination is made that a first device is incapable of normal operation, the first device being in a first edge node. A first communication link model of the first edge node is acquired. The first communication link model includes a detection module in the central node, one or more second devices in the first edge node, and one or more third devices configured to transmit data between the detection module and the one or more second devices. The first communication link model indicates a communication link relationship among the detection module and devices in the first communication link model. Respective operation states of the devices are detected. Link fault information is determined, the link fault information including information of a faulty device in the first communication link model.

### RELATED APPLICATIONS

The present application is a continuation of International Application No. PCT/CN2024/137532, filed on Dec. 6, 2024, which claims priority to Chinese Patent Application No. 202410101673.X, filed on Jan. 24, 2024. The entire disclosures of the prior applications are hereby incorporated by reference.

### FIELD OF THE TECHNOLOGY

This disclosure relates to the field of cloud computing technologies, including a fault processing method and apparatus applied to a distributed cloud scenario.

### BACKGROUND OF THE DISCLOSURE

A distributed cloud is an extension of a capability of a central cloud, and aims to provide a ubiquitous cloud computing service to meet demands of proximity access such as edge data processing and real-time computing. Compared with the central cloud, the distributed cloud may be used at any location, which determines its characteristics of being compact, lightweight, and ultra-low cost. To reduce costs, a distributed cloud node supports at least three devices. A large quantity of unnecessary capabilities are used by remotely connecting the central cloud by using a public network, and requirements on heat radiation and power supply of an Internet data center (IDC) room are greatly reduced. In some aspects, a fault rate of the cloud node may be increased.

In a related technology, a procedure for processing a fault of a distributed cloud node continues to use a general procedure of a central cloud where faults are processed in real time. However, the general procedure is applicable to a central cloud scenario with a large node scale and a low fault rate, but may not be applicable to a scenario with a small distributed cloud node scale and a high fault rate. In some related examples, the distributed cloud node reuses a fault management system of the central cloud by using a public network link. A public network link fault may cause disconnection of an edge node, and devices in the edge node may give alarms in batches. Batch false alarms caused by link interruptions when the devices work normally may further exacerbate operation and maintenance pressure.

### SUMMARY

Embodiments of this disclosure provide a fault processing method and apparatus, a device, and a storage medium, which can facilitate quick discovery of device disconnection in an edge node caused by a link fault, and improving fault processing efficiency.

Some aspects of the disclosure provide a method of fault processing. For example, based on a distributed cloud that includes a central node and one or more edge nodes, a determination is made that a first device is incapable of normal operation, the first device is in a first edge node of the one or more edge nodes of the distributed cloud. A first communication link model of the first edge node is acquired. The first communication link model includes a detection module in the central node, one or more second devices in the first edge node, and one or more third devices configured to transmit data between the detection module and the one or more second devices. The first communication link model indicates a communication link relationship among the detection module, the one or more second devices and the one or more third devices. Respective operation states of devices in the first communication link model are detected. Link fault information in association with the first communication link model is determined, the link fault information indicates information of a faulty device in the first communication link model.

Some aspects of the disclosure provide an apparatus for fault processing. The apparatus includes processing circuitry configured to determine, based on a distributed cloud that includes a central node and one or more edge nodes, that a first device is incapable of normal operation, the first device being in a first edge node of the one or more edge nodes in the distributed cloud. The processing circuitry is configured to acquire a first communication link model of the first edge node, the first communication link model including a detection module in the central node, one or more second devices in the first edge node, and one or more third devices configured to transmit data between the detection module and the one or more second devices, the first communication link model indicating a communication link relationship among the detection module, the one or more second devices and the one or more third devices. The processing circuitry is configured to detect respective operation states of devices in the first communication link model. The processing circuitry is configured to determine link fault information in association with the first communication link model, the link fault information comprising information of a faulty device in the first communication link model.

A non-transitory computer-readable storage medium storing instructions which when executed by at least one processor cause the at least one processor to perform any of the methods of fault processing described herein.

According to a first aspect, an embodiment of this disclosure provides a fault processing method applied to a distributed cloud scenario, the distributed cloud scenario including a central node and at least one edge node, and the method including: determining a first device incapable of operating normally in at least one edge node; acquiring a first communication link model of a first edge node to which the first device belongs, the first communication link model including a detection module in a central node, a second device in the first edge node, and a third device configured to transmit data between the detection module and the second device; and detecting an operation state of each device in the first communication link model, and determining link fault information, the link fault information including information of a faulty device in the first communication link model.

According to a second aspect, an embodiment of this disclosure provides a fault processing apparatus, applied to a distributed cloud scenario, the distributed cloud scenario including a central node and at least one edge node, and the apparatus including: a determination unit, configured to determine a first device incapable of operating normally in at least one edge node; an acquisition unit, configured to acquire a first communication link model of a first edge node to which the first device belongs, the first communication link model including a detection module in a central node, a second device in the first edge node, and a third device configured to transmit data between the detection module and the second device; and a detection unit, configured to detect an operation state of each device in the first communication link model, and determining link fault information, the link fault information including information of a faulty device in the first communication link model.

According to a third aspect, an embodiment of this disclosure provides an electronic device, including: a processor, suitable for implementing computer instructions; a memory, storing the computer instructions, the computer instructions being suitable to be loaded by a processor to perform the method according to the first aspect.

According to a fourth aspect, an embodiment of this disclosure provides a non-transitory computer-readable storage medium. The non-transitory computer-readable storage medium has computer instructions stored therein. The computer instructions, when read and executed by a processor of a computer device, enable the computer device to perform any of the methods described herein.

According to a fifth aspect, an embodiment of this disclosure provides a computer program product or a computer program. The computer program product or the computer program includes computer instructions. The computer instructions are stored in a non-transitory computer-readable storage medium. A processor of a computer device reads the computer instructions from the non-transitory computer-readable storage medium, and the processor executes the computer instructions to enable the computer device to perform any of the methods described herein.

By means of the foregoing technical solutions, in one or more embodiments, when the first device in the edge node is incapable of operating normally, the first communication link model corresponding to the first edge node to which the edge node belongs is acquired, the first communication link model includes the detection module in the central node, the second device in the first edge node, and the third device configured to transmit data between the detection module and the second device, then the operation state of each device in the first communication link model is detected, and the faulty device in the first communication link model is identified. Therefore, in one or more embodiments, when a fault of the edge node occurs, not a device in the edge node is detected, but also devices on a communication link between the detection module in the central node and the device in the edge node are detected, which facilitates quick discovery of a device fault in the edge node caused by a link fault, and improving fault processing efficiency. Further, the link fault is quickly discovered, which can facilitate reducing batch alarms of the device in the edge node, and reducing operation and maintenance pressure.

### BRIEF DESCRIPTION OF THE DRAWINGS

FIG. 1 is a schematic diagram of a network architecture in a distributed cloud scenario.

FIG. 2 is a schematic flowchart of a fault processing method according to an embodiment of this disclosure.

FIG. 3 is a schematic diagram of a network architecture in a distributed cloud scenario according to an embodiment of this disclosure.

FIG. 4 is a schematic flowchart of another fault processing method according to an embodiment of this disclosure.

FIG. 5 is a schematic diagram of a fault detection procedure process according to an embodiment of this disclosure.

FIG. 6 is a schematic diagram of a fault processing procedure according to an embodiment of this disclosure.

FIG. 7 is a schematic block diagram of a fault processing apparatus according to an embodiment of this disclosure.

FIG. 8 is a schematic block diagram of an electronic device according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

In one or more embodiments, “B corresponding to A” indicates that B is associated with A. In an implementation, B may be determined according to A. However, determining B according to A does not mean that B is determined according to A, but that B may be determined according to A and/or other information.

In the descriptions of this disclosure, unless otherwise specified, “at least one” means one or more, and “a plurality of” means two or more. In addition, “and/or” describes an association relationship between associated objects and indicates that three relationships may exist. For example, A and/or B may indicate: only A exists, both A and B exist, and only B exists, where A and B may be singular or plural. Character “/” generally indicates an “or” relationship between associated objects before and after. “At least one (item) of the following” or a similar expression refers to any combination of these items including a single (item) or any combination of a plurality of (items). For example, at least one (item) of a, b, or c may represent: a, b, c, a-b, a-c, b-c, or a-b-c, where a, b, and c may be singular or plural.

Descriptions such as “first” and “second” in embodiments of this disclosure are used for illustrating and distinguishing between described objects, are not sequenced, do not represent a special limitation on a quantity of devices in the embodiments of this disclosure, and do not constitute any limitation on the embodiments of this disclosure.

A specific feature, structure, or characteristic described related to one or more embodiments in the specification is included in at least one embodiment of this disclosure. In addition, these specific features, structures, or characteristics may be combined in one or more embodiments in any proper manner.

In addition, the terms “include”, “have” and any other variants mean to cover the non-exclusive inclusion, for example, a process, method, system, product, or server that includes a series of operations or units is not necessarily limited to those expressly listed operations or units, but may include other operations or units not expressly listed or inherent to the process, method, system, product, or device.

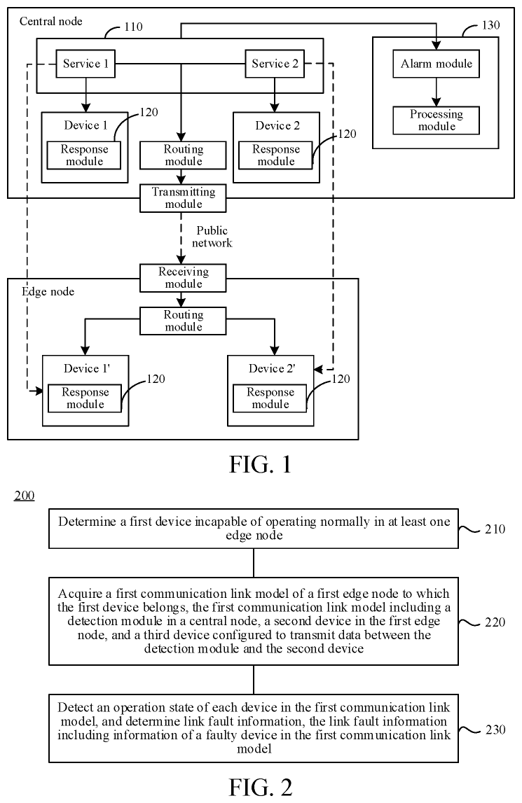

FIG. 1 is a schematic diagram of a network architecture in a distributed cloud scenario.

As shown in FIG. 1, a distributed cloud scenario includes a central node and an edge node. The central node is a central cloud and includes at least one device such as a device 1 and a device 2. The edge node is an edge cloud and includes at least one device such as a device 1′ and a device 2′. There may be a plurality of edge nodes 120.

The distributed cloud may provide various cloud computing services for a terminal. The terminal may alternatively be referred to as a user terminal, and includes, but is not limited to, a mobile phone, a computer, an intelligent voice interaction device, a smart household appliance, a vehicle terminal, an aircraft, and the like.

In a fault processing procedure in a distributed cloud scenario, the central node is mainly responsible for an entire life cycle of fault management. The edge node is responsible for responding to a detection command of the central node and reporting monitoring data. As shown in FIG. 1, a complete fault management link includes a detection module 110, a response module 120, and a fault processing module 130.

The detection module 110 is responsible for initiating device state check. The detection module 110 is deployed in the central node. In some embodiments, when a device state is checked, the detection module 110 may use a service as a unit, and each service independently manages a device of the service. For example, a service 1 manages a corresponding device 1, and a service 2 manages a corresponding device 2. For example, a timer may be built in the detection module 110. When a system is working, the detection module 110 regularly initiates a fault detection heartbeat from a service, to check the survivability of a target device. The detection module 110 may further scan monitoring data reported by the device, to check whether the device is normal.

In a distributed scenario, to reduce operation and maintenance costs, a device of the edge node reuses a fault detection capability of the detection module 110 in the central node. For example, as shown in FIG. 1, the service 1 may further manage the corresponding device 1′, and the service 2 may further manage the corresponding device 2′, for example, by regularly initiating the fault detection heartbeat from within the service to detect the survivability of a corresponding device in the edge node and scanning monitoring data reported by the device in the edge node. When a heartbeat detection failure or a monitoring data abnormality occurs on a device, the device may be considered to have a fault.

The response module 120 is responsible for responding to a detection heartbeat initiated by the service, and reporting monitoring data to the corresponding service. The response module 120 is deployed on the device. For example, the response modules 120 are respectively deployed on the device 1 and the device 2 in the central node, and the response modules 120 are respectively deployed on the device 1′ and the device 2′ in the edge node. In a device fault monitoring process, the response module 120 actively reports real-time state monitoring data of the device, and passively responds to the detection heartbeat. An internal device of the central node and the detection module 110 may directly perform data transmission. Different from the device in the central node, after the detection module 110 in the central node transmits a detection command, data needs to pass through a complex communication link to reach the device in the edge node. As shown in FIG. 1, the communication link may include, for example, a routing module, a transmitting module, and a public network link in the central node, and a receiving module and a routing module in the edge node.

The fault processing module 130 is responsible for completing fault recovery, and the module is deployed in the central node. As shown in FIG. 1, the fault processing module may include an alarm module and a processing module. When a device is detected as faulty, a corresponding service module in the detection module 110 immediately triggers the alarm module to give an alarm, and a related processing module performs fault processing.

In a related technology, in an edge node fault processing procedure, transmission of the heartbeat detection and detection data between the detection module 110 and the response module 120 needs to be completed through a complex communication link. The communication link is a public network control link. A long transmission link and a large quantity of forwarding devices increase uncertainty in data transmission. If the link has a fault, disconnection of an entire edge node is caused, a detection heartbeat cannot be responded to, and state monitoring data cannot be reported. Further, the link fault may further trigger devices in the edge node to give alarms in batches. During daily fault processing, a real alarm needs to be first screened out from a large quantity of invalid alarms. The problem that all devices in the edge node give alarms in batches caused by a single device fault will seriously reduce fault processing efficiency and interfere with normal operation and maintenance of the node.

In view of this, embodiments of this disclosure provide a fault processing method and apparatus, an electronic device, and a storage medium that are applied to a distributed cloud scenario, which can facilitate quick discovery of device disconnection in an edge node caused by a link fault, and improve fault processing efficiency.

In at least one aspect, a distributed cloud scenario includes a central node and at least one edge node. First, a first device incapable of operating normally in the at least one edge node is determined; then, a first communication link model of a first edge node to which the first device belongs is acquired, the first communication link model including a detection module in the central node, a second device in the first edge node, and a third device configured to transmit data between the detection module and the second device; and subsequently, an operation state of each device in the first communication link model is detected, and link fault information is determined, where the link fault information includes information of a faulty device in the first communication link model.

Therefore, in one or more embodiments, when the first device in the edge node is incapable of operating normally, the first communication link model corresponding to the first edge node to which the edge node belongs is acquired, the first communication link model includes the detection module in the central node, the second device in the first edge node, and the third device configured to transmit data between the detection module and the second device, then the operation state of each device in the first communication link model is detected, and the faulty device in the first communication link model is identified. Therefore, in one or more embodiments, when a fault of the edge node occurs, not only a device in the edge node is detected, but also devices on a communication link between the detection module in the central node and the device in the edge node are detected, which facilitates quick discovery of a device fault in the edge node caused by a link fault, and improving fault processing efficiency. Further, the link fault is quickly discovered, which can facilitate reducing batch alarms of the device in the edge node, and reducing operation and maintenance pressure.

The technical solutions of one or more embodiments are described in further detail in the following. The following several embodiments may be combined with each other, and same or similar concepts or processes may not be repeatedly described in some embodiments.

FIG. 2 is a schematic flowchart of a fault processing method 200 applied in a distributed cloud scenario according to an embodiment of this disclosure. The method 200 may be performed by any electronic device having data processing capability. This is not limited in this disclosure.

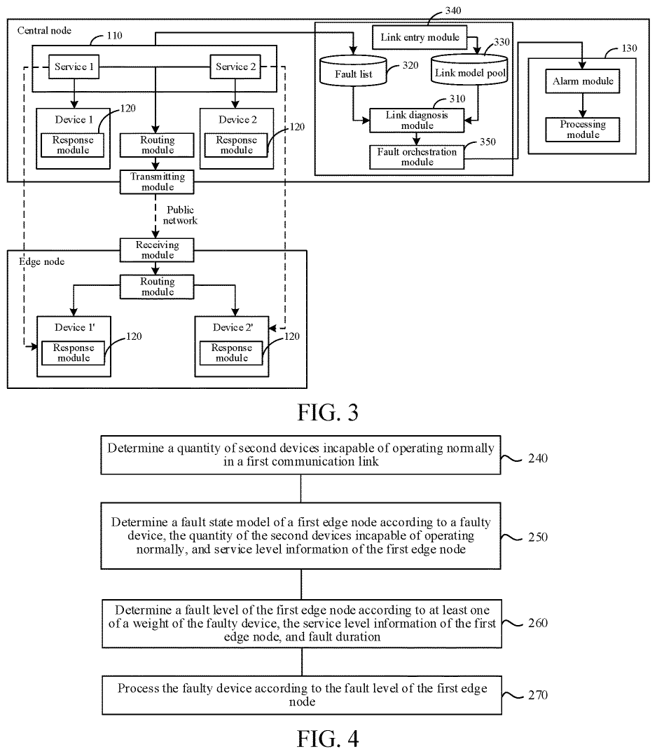

For example, the method 200 may be applied to a network architecture in a distributed cloud scenario shown in FIG. 3. As shown in FIG. 3, the network architecture includes a central node and at least one edge node, a detection module 110, a response module 120, a fault processing module 130, and a link diagnosis module 310. The detection module 110, the response module 120, and the fault processing module 140 are similar to corresponding modules in FIG. 1. Refer to related descriptions in FIG. 1 for examples, and details are not described herein again. The link diagnosis module 310 is deployed in the central node.

In some embodiments, the network architecture may further include at least one of a fault list 320, a link model 330, a link entry module 340, or a fault orchestration module 350. The fault list 320, the link model 330, the link entry module 340, the fault orchestration module 350, and the like may be deployed in the central node.

The method 200 is described below with reference to the network architecture in FIG. 3. As shown in FIG. 2, the method 200 may include operations 210 to 230.

210: Determine a first device incapable of operating normally in at least one edge node.

For example, referring to FIG. 3, services (for example, a service 1 and a service 2) in the detection module 110 may initiate fault detection for the response module 120 of a device (for example, a device 1′ and a device 2′) in the edge node, to detect survivability of a corresponding device in the edge node, and scan monitoring data reported by the device in the edge node. When a heartbeat detection failure or a monitoring data abnormality occurs on a device in the edge node, the detection module 110 determines that the device is incapable of operating normally, or an abnormality exists in the device. In this case, a fault may exist in the first device, or a fault exists in a device (for example, a forwarding device) on a communication link between a response device of the first device and the detection module 110.

The heartbeat detection failure or the monitoring data abnormality may include that a device heartbeat or monitoring data cannot be received, or the heartbeat and monitoring data are received but the monitoring data is abnormal. A fault may exist or may not exist in the first device incapable of operating normally determined in operation 210. For example, when the fault exists in the device on the communication link between the response device of the first device and the detection model 110, the first device may not have a fault.

In some embodiments, the link diagnosis module 310 may acquire information of the first device incapable of operating normally in the at least one edge node from the detection module 110.

In a possible implementation, the detection module 110 may transmit, in real time, the detected information of the first device incapable of operating normally in the edge node to the link diagnosis module.

In another possible implementation, the detection module 110 may transmit, in real time, the detected information of the first device incapable of operating normally in the edge node to the fault list 320 for caching. The fault list 320 includes information of at least one device incapable of operating normally.

In some embodiments, when the communication link between the response module 120 in the edge node and the detection module 110 in the central node has a fault, a plurality of devices in the edge node may be detected as incapable of operating normally simultaneously, and in this case, the plurality of devices are all added to the fault list 320.

Correspondingly, the link diagnosis module 310 may acquire information of the first device from the fault list 320 in a preset manner, so as to determine the first device incapable of operating normally in the edge node. For example, the link diagnosis module 310 may read the information of the first device incapable of operating normally in the fault list 320 one by one in a preset manner. For example, the preset manner may include regularly acquiring, periodically acquiring, or the like. This is not limited in this disclosure.

In at least one aspect, for a scenario with a small edge node scale and a high fault rate, an impact is relatively small when a fault occurs, mostly affecting an interior of the node. Based on this, when the detection module 110 detects that a fault occurs in the edge node, information of a device incapable of operating normally is added to a fault list instead of directly triggering a fault alarm, so that the fault of the edge node having a relatively low requirement on availability does not need to be processed in real time.

220: Acquire a first communication link model of a first edge node to which the first device belongs, the first communication link model including a detection module in a central node, a second device in the first edge node, and a third device configured to transmit data between the detection module and the second device.

For example, still referring to FIG. 3, after determining the first device incapable of operating normally, the link diagnosis module 310 may determine the first edge node to which the first device belongs, and further acquire the first communication link model of the first edge node.

In at least one aspect, the first communication link model includes a communication network between the central node (for example, the detection module) and the edge node (for example, the response module). The first communication link model may be determined according to basic information of devices in a communication link between the central node (for example, the detection module) and the edge node (for example, the response module) and a connection relationship between the devices.

In some embodiments, the first communication link model includes a tree structure using the detection module as a root node, the second device in the first edge node as a leaf node, and a third device configured to transmit data between the detection module and the second device as an intermediate node. The root node and the intermediate node in the tree structure record devices corresponding to child nodes of the root node and the intermediate node. A device corresponding to a child node of a node is a subsequent device of the node, and the leaf node does not have a subsequent device. In some embodiments, a device corresponding to the root node may be referred to as a root device, and a device corresponding to the leaf node may be referred to as a leaf device.

In at least one aspect, on the communication link between the detection module of the central node and the device of the edge node, a next-hop downstream device of the root node or the intermediate node is a subsequent device of the root node or the intermediate node. The root node and the intermediate node record devices corresponding to the child nodes of the root node and the intermediate node, that is, subsequent devices, so that the communication link model can accurately and effectively represent the communication network between the central node and the edge node.

In some embodiments, the second device may include the foregoing first device.

In at least one aspect, the second device is a device in the first edge node, and the first device belongs to the first edge node. That is, the first device is the device incapable of operating normally in the first edge node. When all devices in the first edge node are incapable of operating normally, the first device and the second device are the same device. When some devices in the first edge node are incapable of operating normally, the first device is a subset of the second device.

In some embodiments, when a plurality of devices incapable of operating normally in an edge node are simultaneously detected, the plurality of devices are all added to the fault list 320. Further, because the plurality of devices belong to the same edge node, only a communication link network of the edge node needs to be acquired.

In some embodiments, a communication link model of the at least one edge node may further be acquired; and the communication link model of the at least one edge node is stored in a link model pool. The link model pool may include a communication link model of at least one edge node. In some embodiments, the link model pool may include communication link models of all edge nodes. In this case, the first communication link model of the first edge node to which the first device belongs may be acquired from the link model pool according to the information of the first device.

For example, still referring to FIG. 3, the link entry module 340 is responsible for completing construction of the communication link model of the edge node, for example, acquiring the communication link model of the at least one edge node in advance, and storing the communication link model of the at least one edge node in the link model pool 330. For example, the communication link model may be stored by using an edge node identifier as a key.

In some embodiments, the link entry module 340 may further enter a service level provided by the edge node. For different service levels, fault processing policies of different response levels may be provided. In some embodiments, the service level may be saved in the link model pool.

In the method 200, description is made by using an example in which the first device in the first edge node is incapable of operating normally. A fault processing procedure when a device in another edge node in a distributed cloud scenario is incapable of operating normally is similar to a processing procedure corresponding to the first device in the first edge node. For details, refer to related descriptions as examples, and details are not described in this disclosure again.

230: Detect an operation state of each device in the first communication link model, and determine link fault information, the link fault information including information of a faulty device in the first communication link model.

For example, based on a distributed cloud that includes a central node and one or more edge nodes, a determination is made that a first device is incapable of normal operation, the first device is in a first edge node of the one or more edge nodes of the distributed cloud. A first communication link model of the first edge node is acquired. The first communication link model includes a detection module in the central node, one or more second devices in the first edge node, and one or more third devices configured to transmit data between the detection module and the one or more second devices. The first communication link model indicates a communication link relationship among the detection module, the one or more second devices and the one or more third devices. Respective operation states of devices in the first communication link model are detected. Link fault information in association with the first communication link model is determined, the link fault information includes information of a faulty device in the first communication link model.

For example, still referring to FIG. 3, the link diagnosis module 310 may detect, for the communication link model of the edge node to which the device incapable of operating normally belongs, operation states of the devices in the communication link model in sequence according to the operation states of the devices in the edge node, that is, detect the detection module in the central node, the device of the edge node, and the devices (for example, a forwarding device) on the communication link between the detection module and the device of the edge node in sequence, until the faulty device is detected. Then, fault link information may be determined according to the information of the faulty device.

In some embodiments, for a plurality of devices incapable of operating normally in the same edge node in the fault list 320, the operation states of the devices in the communication link network of the edge node are detected, so that batch alarms caused by the same device fault can be merged and alarm abuse can be avoided.

Therefore, in one or more embodiments, when a fault occurs, not only a device in the edge node can be detected, but also devices on a communication link between the detection module in the central node and the device in the edge node can be detected, which facilitates quick discovery of a device fault in the edge node caused by a link fault, and improving fault processing efficiency. Further, the link fault is quickly discovered, which can facilitate reducing batch alarms of the device in the edge node, and reducing operation and maintenance pressure.

Further, the detected information of the device incapable of operating normally is added to the fault list, so as to read the information of the device incapable of operating normally from the fault list, and perform fault detection on the devices in the communication link model of the edge node instead of directly triggering a fault alarm, thereby converging a fault processing entrance, merging batch alarms caused by the same device fault, and avoiding alarm abuse.

In some embodiments, when the first communication link model includes a tree structure using the detection module as a root node, the second device in the first edge node as a leaf node, and a third device configured to transmit data between the detection module and the second device as an intermediate node, operation states of nodes in the tree structure may be traversed in sequence from the detection module (that is, the root device) corresponding to the root node, thereby determining a faulty device in the first communication link model. Then, fault link information may be determined according to the information of the faulty device.

For example, a node currently detected in the first communication link model may be referred to as a current node. The current node may be a root node, an intermediate node, or a leaf node. For the current node, whether a device corresponding to the current node operates normally may be detected. If the current node is incapable of operating normally, the device corresponding to the current node is determined as the faulty device.

In some embodiments, if the current node operates normally and a child node exists for the current node, whether a device (that is, a subsequent device) corresponding to the child node of the current node is normal is detected. In this case, a next current node may be updated as a device corresponding to the child node.

In some embodiments, if the current node operates normally, and the child node does not exist for the current node, a sibling node of the current node may be checked, that is, whether a device corresponding to the sibling node is normal is checked. In this case, a next current node may be updated as a brother device.

In some embodiments, if the current node is incapable of operating normally, a sibling node of the current node may further be checked, to traverse the tree structure corresponding to the entire first communication link model, thereby avoiding omission of a faulty device that may exist in the sibling node. When the brother device does not exist in the current node, the tree structure corresponding to the entire first communication link model is traversed.

Therefore, in this disclosure, the devices in the first communication link model are traversed in sequence. When a device responds normally and detection data is normal, the device is a normal device, and a subsequent device of the device may continue to be detected along the first communication link model. When a device fails to respond or the detection data is abnormal, the device is marked as a faulty device, subsequent devices of the device may be ignored, and a brother device of the device is traversed instead, to traverse and check the first communication link model, thereby facilitating rapid discovery of a link fault.

Further, in this disclosure, failure metadata can be collected by detecting a survival state of the devices in the communication link model or the detection data, thereby acquiring information of the faulty device. The fault metadata can be configured for identifying a fault type, thereby improving accuracy of fault identification.

In some embodiments, the information of the faulty device may further include time information of the fault. The time information of the fault may be configured for determining fault duration.

In some embodiments, referring to FIG. 4, the method 200 may further include the following operations 240 and 250.

240: Determine a quantity of second devices incapable of operating normally in a first communication link.

For example, when the devices in the first communication link model are traversed and checked, a quantity of unreachable leaf devices in the first communication link model may be counted. The unreachable leaf devices are devices incapable of operating normally in the first edge node. The second device incapable of operating normally is a subset of the second device in operation 220. For the failure to operate normally, refer to the related descriptions above.

250: Determine a fault state model of a first edge node according to a faulty device, the quantity of the second devices incapable of operating normally, and service level information of the first edge node.

In at least one aspect, the fault state model may be determined according to the information of the faulty device in the first communication link model, the quantity of unreachable leaf devices in the first communication link model, the service level information of the first edge node, and the like.

In some embodiments, the fault state model may further be saved to a link state pool. For example, an identifier of the faulty device may be used as a key to perform deduplication on the fault state model and save the fault state model to the link state pool. For example, when the key in the link state pool already includes an identifier of a faulty device, a fault state model corresponding to the faulty device in the link state pool may be updated.

In this disclosure, the fault state model is saved to the link state pool, instead of directly triggering a fault alarm or modifying a fault, so that a fault of an edge node having a relatively low requirement on availability does not need to be processed in real time, thereby facilitating reducing operation and maintenance costs.

When all devices are found to be normal after the first communication link model is traversed, a system works normally. When a faulty device is discovered after the communication link model is traversed, a fault exists in the system, and the faulty device needs to be further processed. For example, the fault processing module completes fault recovery according to a link state.

In a related technology, in a standard fault processing procedure, after a fault is manually confirmed for a second time, a fault processing module is selected to process a fault. This processing manner needs to provide a manual service of 7×24 hours, is suitable for a central cloud with a stable operating environment and a low fault rate, but is not suitable to be applied to a distributed cloud scenario with many uncontrollable factors, a relatively high fault rate, and a limited fault impact range. Further, as data of distributed cloud nodes increases, costs of manual processing rapidly increase.

In view of this, in this disclosure, a fault level of the first edge node is further determined according to a detection result of the first communication link model, and the faulty device is further processed according to the fault level. Grading processing is performed on the fault, which facilitates immediate processing of a high-priority fault, and downgrading a low-priority fault, to effectively reduce the number of times of manually processing faults in real time, improve overall fault processing efficiency, and reduce maintenance costs.

In some embodiments, still referring to FIG. 4, the method 200 may further include operations 260 and 270.

260: Determine a fault level of the first edge node according to at least one of a weight of the faulty device, the service level information of the first edge node, or fault duration.

For example, still referring to FIG. 3, the fault orchestration module 350 may determine the fault level of the first edge node according to at least one of the weight of the faulty device, the service level information of the first edge node, or the fault duration.

For example, the fault orchestration module 350 may acquire link fault information from the link diagnosis module 310, and determine at least one of the weight of the faulty device, the service level information of the first edge node, or the fault duration according to the link fault information. For example, the fault orchestration module 350 may acquire the fault state model from the link state pool in a preset manner. For example, the preset manner may include regularly acquiring, periodically acquiring, or the like. This is not limited in this disclosure. Then, at least one of the weight of the faulty device, the service level information of the first edge node, or the fault duration may be acquired according to the fault state model.

In some embodiments, a grading score may be determined according to the weight of the faulty device, the service level information of the first edge node, and the fault duration, and the fault level is further determined according to the grading score. For example, the grading score S may be shown in the following formula (1):

$$S = \{ \begin{matrix}\sum error\_count * level\_vip + time , & level\_vip < 3 \\ max\_score , & level\_vip \geq 3\end{matrix} \qquad ( 1 )$$

where error_count represents the weight of the faulty device, and a weight of each device may be set according to importance of the device in the communication link model; Σ error_count is a sum of weights of all subsequent devices affected by the faulty device; level_vip represents service level information, and is an availability level of an edge node that is recorded in advance, where a higher node availability requirement indicates a higher service level; time represents a fault duration coefficient, and is positively correlated to the fault duration; and max_score is a maximum score. A larger value of the calculated grading score S indicates a higher processing priority.

In formula (1), when the service level of the edge node is greater than or equal to 3, the grading score is a highest score max_score. When the service level of the edge node is less than 3, the grading score is calculated according to the quantity and weight of the faulty device, the service level information of the edge node, and the fault duration. In this case, a larger number of devices affected by the fault indicates a higher service level of the edge node, or a device having a longer fault duration has a higher grading score.

For example, max_score the value may be 30. This is not limited in this disclosure.

270: Process the faulty device according to the fault level of the first edge node.

For example, still referring to FIG. 3, the fault orchestration module 350 may determine a policy for processing the faulty device according to the fault level of the first edge node. In at least one aspect, for different fault levels, different response processing may be performed. For example, the high-priority fault is immediately processed, and a low-priority fault is downgraded. For example, idle time may be waited for processing.

For example, for the grading score obtained according to the foregoing formula (1), when the score reaches max_score, the fault needs to be immediately processed. When the service level is greater than or equal to 3, a real-time response needs to be provided for all faults. When the service level is less than 3, processing is performed according to the calculated grading score. For example, a larger quantity of devices affected by the fault indicates a higher service level of the edge node, or a device having longer fault duration has a higher grading score, and has a higher corresponding processing priority.

For example, for the high-priority fault, a response of 7×24 hours may be provided, and for a fault with a relatively small impact range (for example, the quantity of faulty devices is relatively small), idle time may be waited for processing. In some embodiments, for a fault that has a fault type capable of being accurately identified and has an automatic processing method, automatic recovery processing may be attempted in an example, thereby reducing manual participation. For a fault type for which automatic recovery processing cannot be performed, a standard processing procedure may be entered, and manual processing is performed after secondary manual confirmation. Therefore, one or more embodiments can effectively reduce the number of times of manually processing faults in real time, improve overall fault processing efficiency, and reduce maintenance costs.

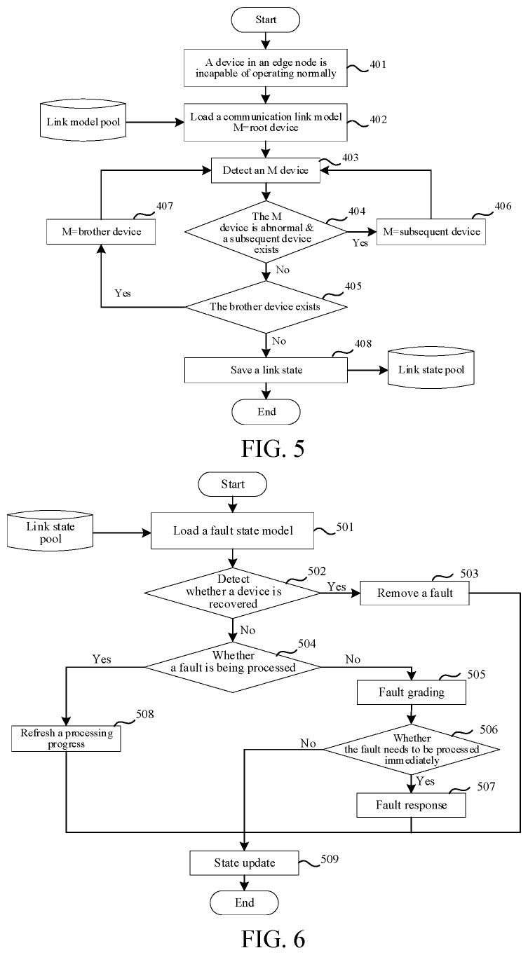

FIG. 5 is a schematic diagram of a fault detection procedure according to an embodiment of this disclosure. FIG. 5 shows operations related to a fault detection procedure, but these operations are examples. Other operations or variations of the operations in FIG. 5 may further be performed in this disclosure. In addition, operations in FIG. 5 may be performed in a sequence different from that presented in FIG. 5, and it is possible that not all the operations in FIG. 5 are performed. As shown in FIG. 5, the fault detection procedure includes operations 401 to 408.

401: A device in an edge node is incapable of operating normally.

In at least one aspect, a fault occurs in the edge node, and the device incapable of operating normally exists. In this case, information of the device incapable of operating normally in the edge node may be acquired. In at least one aspect, for a process of acquiring the information of the device incapable of operating normally, refer to related descriptions of operation 210 in FIG. 2, and details are not described herein again.

402: Load a communication link model. M=root device.

As shown in FIG. 5, the communication link model of the edge node to which the device incapable of operating normally belongs may be acquired from a link model pool. For example, the corresponding communication link model may be loaded according to an ID of the edge node to which the device incapable of operating normally belongs.

In a possible implementation, when a device incapable of operating normally in an edge node is detected, a module may be automatically activated to load a communication link model of the edge node to which the device incapable of operating normally belongs. For example, the communication link model may be a tree structure using a detection module in a central node as a root node, and the devices record subsequent devices of the devices. When a device does not have a subsequent device, the device is a leaf device. The device in the edge node is a leaf device.

In at least one aspect, for a process of loading the communication link model, refer to related descriptions in operation 220 in FIG. 2, and details are not described herein again.

After the communication link model is loaded, a device (that is, the root device) corresponding to the root node in the communication link model may be configured as a current detection device, that is, an M device. Then, survival states and detection data of the devices are detected along the communication link model in sequence by using the root device as a starting point, until a faulty device is discovered.

In at least one aspect, the detection process may include the following operations 403 to 407.

403: Detect an M device.

In at least one aspect, a survival state and monitoring data of the device M may be detected, to determine whether the device M is a normal device.

404: Determine whether the M device is normal and a subsequent device exists.

For example, when the device responds normally and the monitoring data is normal, the device is the normal device. In this case, whether the subsequent device exists for the M device may be determined according to the loaded communication link model. When the subsequent device exists for the M device, operation 406 may be performed.

When the two conditions that the M device is normal and the subsequent device exists cannot be satisfied simultaneously, for example, when the M device is incapable of operating normally, or the subsequent device does not exist for the M device, operation 405 may be performed.

405: Determine whether a brother device exists.

When the brother device exists, operation 407 is performed next. When the brother device does not exist, the communication link model is traversed and checked.

When the device Mis incapable of operating normally, because the subsequent device of the device M cannot receive forwarded data from the device M, the subsequent device of the device Mis incapable of operating normally. In this case, the subsequent device of the M device does not need to be detected. Correspondingly, whether the brother device exists for the M device may be determined, to traverse the devices in the communication link model in sequence.

When the M device operates normally, but the subsequent device does not exist for the M device, the M device is already a leaf node in a current communication network branch, and the communication network branch is capable of operating normally. In this case, whether the brother device exists for the M device may be determined, to traverse the devices in the communication link model in sequence.

406: M=subsequent device.

In at least one aspect, the subsequent device of the M device in operation 403 may be configured as a current M device.

407: M=brother device.

In at least one aspect, the brother device of the M device in operation 403 may be configured as a current M device.

After operation 406 or 407 is performed, operation 403 may be performed to perform detection on the M device.

By cyclically performing operations 403 to 407, a depth-first method can be used to traverse the devices in the tree structure from the root device in sequence, to detect whether the devices are capable of operating normally. When a device responds normally and detection data is normal, the device is a normal device, and the subsequent device of the device may continue to be detected along the communication link model. When a device fails to respond or the detection data is abnormal, the device is marked as a faulty device, and the subsequent device of the device may be ignored, and the brother device of the device is traversed instead, to traverse and check the communication link model.

When all devices are found to be normal after the communication link model is traversed, a system works normally. When a faulty device is discovered after the communication link model is traversed, a fault exists in the system, and the faulty device needs to be further processed. For example, the following operation 408 may be performed.

408: Save a link state.

For example, the checked faulty device in the communication link model may be saved to the link state pool as the link state.

In some embodiments, when the communication link model is traversed, a quantity of unreachable leaf devices in the communication link model may further be counted. In some embodiments, the link state may further include the quantity of unreachable leaf devices in the communication link model. In some embodiments, the link state may further include service level information of edge node.

As an implementation, information such as the faulty device in the communication link model, the quantity of unreachable leaf devices, and the service level information of the edge node in the communication link model may be encapsulated into the link state model, and the link state model is saved in the link state pool by using an identifier of the faulty device as a key. Correspondingly, a fault processing module may acquire each link state model from the link state pool, and process the fault according to the link state model.

Therefore, in this disclosure, a device incapable of operating normally exists in the edge node, the devices in the communication link model of the edge node are detected, thereby converging a fault processing entrance, merging batch alarms caused by the same device fault in the communication link model, and facilitating avoiding alarm abuse. A statistical result indicates that in the fault processing procedure provided in this disclosure, an average monthly alarm frequency of each distributed edge cloud node is reduced from 18 to 1.3, which reduces invalid alarms by 93% monthly.

FIG. 6 is a schematic diagram of a fault processing procedure according to an embodiment of this disclosure. FIG. 6 shows operations related to a fault processing procedure, but these operations are examples. Other operations or variations of the operations in FIG. 6 may further be performed in this disclosure. In addition, operations in FIG. 6 may be performed in a sequence different from that presented in FIG. 6, and it is possible that not all the operations in FIG. 6 are performed. As shown in FIG. 6, the fault detection procedure includes operations 501 to 509.

501: Load a fault state model.

For example, the fault state model may be regularly loaded from the link state pool. As an implementation, a timer may be built in a module, to regularly trigger full scheduling once. In at least one aspect, when a scheduling task is started, all unprocessed fault state models may be loaded from the “link state pool”.

In some embodiments, a processing process of each fault state model may occupy one execution thread. In this way, scheduling of the state fault model may be initiated in batches in a multi-threaded manner.

502: Detect whether a device is recovered.

In some examples, to help ensure real-time performance of link diagnosis data and avoid a fault orchestration abnormality caused by stale data, link diagnosis may be initiated again before fault orchestration is started to acquire a latest link state. When the fault is detected as recovered, operation 503 is performed. For a fault that does not start to be processed, operation 504 is performed.

503: Remove a fault.

In at least one aspect, when the fault is found by detection to have been recovered, the corresponding fault state model may be removed from the link state pool, and this scheduling is ended.

504: Determine whether a fault is being processed?

For a fault that does not start to be processed, whether the fault is a fault that is being processed may further be determined. Operation 508 may be performed for the fault that is being processed. For a fault that is not being processed, operation 505 may be performed.

505: Fault grading.

In at least one aspect, because a fault rate in a distributed cloud scenario is much higher than that in a central cloud scenario, to improve fault processing efficiency and help ensure high-priority processing of major faults, the faults need to be graded. For example, a fault level of the edge node may be determined according to at least one of a weight of the faulty device, service level information of the edge node, or fault duration. For example, a grading score may be calculated according to the foregoing formula (1), and a fault level is further determined according to the grading score.

506: Determine whether the fault needs to be processed immediately.

When the fault needs to be processed immediately, operation 507 may be performed. When the fault does not need to be processed immediately, operation 509 may be performed.

For example, for a case in which the service level is greater than or equal to 3, a real-time response may be provided, that is, the fault processing needs to be immediately performed. When the service level is less than 3, corresponding processing may be performed according to the calculated grading score. For example, a fault with a grading score less than a value may not be processed immediately. For example, idle time is waited for processing.

507: Fault response.

In at least one aspect, for a fault that needs to be processed immediately, different responses may be performed according to different fault levels. For example, for a high-priority fault, a response of 7×24 may be provided; and for a fault with a relatively small impact range (for example, the quantity of faulty devices is relatively small), downgrading may be performed. In a fault processing procedure, for a fault that has a fault type capable of being accurately identified and has an automatic processing method, automatic recovery may be attempted in an example, thereby reducing manual participation. For a fault for which automatic recovery cannot be performed, a standard processing procedure may be entered, and the fault is manually processed after secondary manual confirmation.

508: Refresh a processing progress.

In at least one aspect, for the fault that is being processed, a processing progress may be refreshed.

509: State update.

In at least one aspect, a state fault may be updated after the fault processing is completed, or for the fault that does not need to be processed immediately. For example, for the processed fault, a fault state model corresponding to the fault may be removed from the link state pool; and the fault that does not need to be processed immediately may wait to be scheduled next time.

Therefore, in this disclosure, according to a fault level, fault downgrading, upgrading, and automatic recovery processing are performed as required, which can facilitate high-priority processing of major faults, improve overall processing efficiency, and effectively reduce the number of times of real-time manual processing. A statistical result indicates that, for each distributed edge node, an average monthly number of times of manually processing faults in real time is reduced from 0.8 to 0.3, and manual operation and maintenance costs are already close to that of the central cloud.

Implementations of this disclosure are described above with reference to the accompanying drawings. However, this disclosure is not limited to specific details in the foregoing implementations. In the scope of the technical concept of this disclosure, a plurality of simple variations can be made to the technical solutions of this disclosure, and these simple variations all fall within the scope of this disclosure. For example, each specific technical feature described in the foregoing specific implementations can be combined in any suitable way without contradiction. To avoid unnecessary repetition, various possible combinations are not described in this disclosure. For another example, different implementations of this disclosure may alternatively be arbitrarily combined without departing from the idea of this disclosure, and these combinations shall still be regarded as content disclosed in this disclosure.

Sequence numbers of the foregoing processes do not mean execution sequences in various embodiments of this disclosure. The execution sequences of the processes need to be determined according to functions and internal logic of the processes, and do not need to be construed as any limitation on the implementation processes of the embodiments of this disclosure. These sequence numbers may be interchanged in an appropriate condition, so that the embodiments of this disclosure described can be implemented in an order other than those illustrated or described.

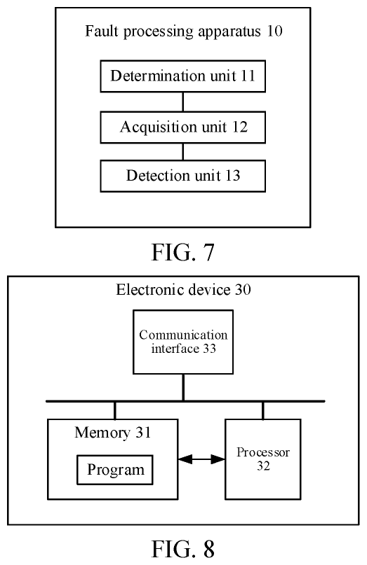

Method embodiments of this disclosure are described above with reference to FIG. 1 to FIG. 6, and apparatus embodiments of this disclosure are described below with reference to FIG. 7 to FIG. 8.

FIG. 7 is a schematic block diagram of a fault processing apparatus 10 according to an embodiment of this disclosure. The apparatus 10 may be applied to a distributed cloud scenario. The distributed cloud scenario includes a central node and at least one edge node. As shown in FIG. 7, the apparatus 10 may include a determination unit 11, an acquisition unit 12, and a detection unit 13.

The determination unit 11 is configured to determine a first device incapable of operating normally in at least one edge node.

The acquisition unit 12 is configured to acquire a first communication link model of a first edge node to which the first device belongs, the first communication link model including a detection module in a central node, a second device in the first edge node, and a third device configured to transmit data between the detection module and the second device.

The detection unit 13 is configured to detect an operation state of each device in the first communication link model, and determine link fault information, the link fault information including information of a faulty device in the first communication link model.

In some embodiments, the first communication link model includes a tree structure using the detection module as a root node, the second device as a leaf node, and the third device as an intermediate node, and the root node and the intermediate node in the tree structure record devices corresponding to child nodes of the root node and the intermediate node.

In some embodiments, the detection unit 13 is specifically configured to:
traverse operation states of nodes in the tree structure in sequence from the detection module corresponding to the root node, and determine the faulty device in the first communication link model; and
determine the link fault information according to the information of the faulty device.

In some embodiments, the detection unit 13 is specifically configured to:
detect whether a device corresponding to a current node in a first communication link operates normally, the current node including the root node, the intermediate node, or the leaf node; and
determine, if the current node is incapable of operating normally, the device corresponding to the current node as the faulty device.

In some embodiments, the detection unit 13 is further configured to:
detect, if a sibling node exists for the current node, whether a device corresponding to the sibling node is normal.

In some embodiments, the detection unit 13 is further configured to:
detect, if the current node operates normally and a child node exists for the current node, whether a device corresponding to the child node of the current node is normal.

In some embodiments, the determination unit 11 is specifically configured to:
acquire, from the detection module, information of the first device incapable of operating normally in the at least one edge node, the detection module being configured to acquire operation states of the central node and the devices in the at least one edge node.

In some embodiments, the apparatus 10 further includes a cache unit, configured to:
acquire, from a fault list, the information of the first device incapable of operating normally in the at least one edge node, the fault list being configured for caching information of at least one device incapable of operating normally from the detection module.

In some embodiments, the acquisition unit 12 is specifically configured to:
acquire the first communication link model of the first edge node to which the first device belongs from a link model pool according to the information of the first device, the link model pool including a communication link model of the at least one edge node.

In some embodiments, the apparatus 10 further includes a processing unit, configured to:
determine a fault level of the first edge node according to at least one of a weight of the faulty device, service level information of the first edge node, or fault duration; and
process the faulty device according to the fault level of the first edge node.

In some embodiments, the determination unit 11 is further configured to:
determine a quantity of second devices incapable of operating normally in the first communication link;
determine a fault state model of the first edge node according to the link fault information, the quantity of the second devices incapable of operating normally, and the service level information of the first edge node; and
determine at least one of the weight of the faulty device, the service level information, or the fault duration according to the fault state model.

The apparatus embodiments correspond to the method embodiments. Similar description may refer to the method embodiments. To avoid repetition, details are not described herein. In at least one aspect, when the fault processing apparatus 10 in this embodiment may correspondingly perform the fault processing method 200 of this disclosure, the foregoing and other operations and/or functions of each module in the apparatus 10 are respectively used for implementing corresponding procedures in methods in FIG. 2. For simplicity, details are not described herein.

The apparatus and system of the embodiments of this disclosure are described above from a perspective of functional modules in combination with accompanying drawings. The functional modules may be implemented in a form of hardware, or may be implemented in a form of software, or may be implemented in a combination of hardware and software modules. In at least one aspect, operations of the method embodiments in the embodiments of this disclosure may be completed by instructions in the form of hardware integrated logic circuits and/or software in the processor, and operations of the methods disclosed with reference to the embodiments of this disclosure may be directly performed and completed by using a hardware decoding processor, or may be performed and completed by using a combination of hardware and software modules in the decoding processor. In some embodiments, the software module may be located in a mature storage medium in the art, such as a random access memory, a flash memory, a read-only memory, a programmable read-only memory, an electrically-erasable programmable memory, and a register. The storage medium is located in the memory, and the processor reads information in the memory and completes the operations in the above method embodiments in combination with hardware.

FIG. 8 is a schematic block diagram of an electronic device 30 according to an embodiment of this disclosure.

As shown in FIG. 8, the electronic device 30 may include: a memory 31 and a processor 32. The memory 31 is configured to store a computer program and transmit the computer program to the processor 32. The processor 32 may call and run the computer program from the memory 31 to implement the method in the embodiments of this disclosure.

For example, the processor 32 may be configured to perform operations of execution bodies in the foregoing method 200 according to instructions in the computer program, including: determining a first device incapable of operating normally in at least one edge node; acquiring a first communication link model of a first edge node to which the first device belongs, the first communication link model including a detection module in a central node, a second device in the first edge node, and a third device configured to transmit data between the detection module and the second device; and detecting an operation state of each device in the first communication link model, and determining link fault information, the link fault information including information of a faulty device in the first communication link model.

In some embodiments of this disclosure, the processor 32 may include, but is not limited to: a universal processor, a digital signal processor (DSP), an application specific integrated circuit (ASIC), a field programmable gate array (FPGA) or other programmable logic devices, discrete gates or transistor logic devices, discrete hardware components, and the like.

In some embodiments of this disclosure, the memory 31 may include, but is not limited to: a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be random access memory (RAM), which is used as an external cache. For example, RAMs in many forms, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct Rambus RAM (DRRAM), are available.

In some embodiments of this disclosure, the computer program may be partitioned into one or more units. The one or more units are stored in the memory 31 and are executed by the processor 32 to complete the method provided by this disclosure. The one or more modules may be a series of computer program instruction segments capable of completing specific functions, and the instruction segments are used to describe an execution process of the computer program in the electronic device 30.

In some embodiments, as shown in FIG. 8, the electronic device 30 may further include: a communication interface 33. The communication interface 33 may be connected to the processor 32 or the memory 31.

The processor 32 may control the communication interface 33 to communicate with other devices. In at least one aspect, the processor 32 may transmit information or data to other devices, or receive the information or data transmitted by other devices. For example, the communication interface 33 may include a transmitter and a receiver. The communication interface 33 may further include an antenna, and there may be one or more antennas.

Various components in the electronic device 30 are connected through a bus system. In addition to a data bus, the bus system further includes a power bus, a control bus, and a state signal bus.

According to an aspect of this disclosure, a communication apparatus is provided, including a processor and a memory. The memory is configured to store a computer program. The processor is configured to call and run the computer program stored in the memory, so that the processor performs the method in the foregoing method embodiments.

According to an aspect of this disclosure, a computer storage medium is provided, which has a computer program stored therein. The computer program, when executed by a computer, enables the computer to perform the method in the foregoing method embodiments. Alternatively, an embodiment of this disclosure further provides a computer program product including instructions. The instructions, when executed by a computer, enable the computer to perform the method in the foregoing method embodiments.

According to another aspect of this disclosure, a computer program product or a computer program is provided. The computer program product or the computer program includes computer instructions. The computer instructions are stored in a non-transitory computer-readable storage medium. A processor of a computer device reads the computer instructions from the non-transitory computer-readable storage medium, and the processor executes the computer instructions to enable a computer device to perform the method in the foregoing method embodiments.

In other words, when implemented by using software, all or some of the foregoing embodiments may be implemented in a form of a computer program product. The computer program product includes one or more computer instructions. When the program instructions of the computer are loaded and executed on the computer, all or some of procedures or functions of the embodiments of this disclosure are generated. The computer may be a general-purpose computer, a dedicated computer, a computer network, or other programmable apparatuses. The computer instructions may be stored in a non-transitory computer-readable storage medium or transmitted from one non-transitory computer-readable storage medium to another non-transitory computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The non-transitory computer-readable storage medium may be any available medium accessible by a computer, or a data storage device such as a server or a data center integrated by one or more available media. The available medium may be a magnetic medium (for example, a soft disc, a hard disc, or a magnetic tape), an optical medium (for example, a digital video disc (DVD)), a semiconductor medium (for example, a solid-state drive (SSD)), or the like.

In a specific implementation of this disclosure, when the above embodiments of this disclosure are applied to a specific product or technology and relevant data such as user information is involved, a permission or consent of a user needs to be obtained, and collection, use, and processing of the related data need to comply with relevant laws, regulations, and standards.

Those of ordinary skill in the art may be aware that the modules and algorithm operations in examples described with reference to the embodiments disclosed herein can be implemented by electronic hardware or a combination of computer software and electronic hardware. Whether the functions are executed in a manner of hardware or software depends on specific applications and design constraint conditions of the technical solutions. Those skilled in the art may use different methods to implement the described functions for each specific application, but such implementation is not to be considered as going beyond the scope of this disclosure.

In several embodiments provided in this disclosure, the disclosed device, apparatus, and method may be implemented in other manners. For example, the apparatus embodiments described above are a few examples. For example, the module division is logical function division and may be other division in actual implementation. For example, a plurality of modules or components may be combined or integrated into another system, or some features may be ignored or not performed. In addition, the displayed or discussed mutual couplings or direct couplings or communication connections may be direct couplings or communication connections between an apparatus and a module through some interfaces, and may be electric, mechanical, or other forms.

Modules described as separate components may or may not be physically separate, and components displayed as modules may or may not be physical modules, that is, may be located in one place or distributed across over a plurality of network units. Some or all of the modules may be selected according to actual needs to achieve the objectives of the solutions of the embodiments. For example, various functional modules in various embodiments of this disclosure may be integrated into one processing module, or various modules may exist physically independently, or two or more modules may be integrated into one module.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of fault processing, the method comprising:
determining, based on a distributed cloud that includes a central node and one or more edge nodes, that a first device is incapable of normal operation, the first device being in a first edge node of the one or more edge nodes in the distributed cloud;
acquiring a first communication link model of the first edge node, the first communication link model comprising a detection module in the central node, one or more second devices in the first edge node, and one or more third devices configured to transmit data between the detection module and the one or more second devices, the first communication link model indicating a communication link relationship among the detection module, the one or more second devices and the one or more third devices;
detecting respective operation states of devices in the first communication link model; and
determining link fault information in association with the first communication link model, the link fault information comprising information of a faulty device in the first communication link model.

2. The method according to claim 1, wherein the first communication link model comprises a tree structure that includes:
the detection module as a root node of the tree structure that records child nodes of the root node,
the one or more second devices as leaf nodes of the tree structure, and
the one or more third devices as intermediate nodes of the tree structure that record respective child nodes of the intermediate nodes.

3. The method according to claim 2, wherein the determining the link fault information comprises:
traversing operation states of nodes in the tree structure from the root node corresponding to the detection module,
determining the faulty device in the first communication link model based on the operation states of the nodes; and
determining the link fault information according to the information of the faulty device.

4. The method according to claim 3, wherein the determining the faulty device comprises:
detecting whether a corresponding device to a current node in the tree structure is in normal operation; and
determining, when the current node is incapable of normal operation, the corresponding device to the current node as the faulty device.

5. The method according to claim 4, further comprising:
detecting, when a sibling node exists for the current node, whether a device corresponding to the sibling node is in normal operation.

6. The method according to claim 4, further comprising:
detecting, when the current node is in normal operation and a child node exists for the current node, whether a device corresponding to the child node of the current node is in normal operation.

7. The method according to claim 1, wherein the determining that the first device is incapable of normal operation comprises:
acquiring, from the detection module in the central node of the distributed cloud, information of the first device that is incapable of normal operation, the detection module being configured to acquire operation states of the central node and the devices in the first communication link model.

8. The method according to claim 1, further comprising:
acquiring, from a fault list, information of the first device that is incapable of normal operation, the fault list being configured for caching information of at least one device that is incapable of normal operation, the information of the at least one device being obtained from the detection module.

9. The method according to claim 8, wherein the acquiring the first communication link model comprises:
acquiring the first communication link model of the first edge node from a link model pool according to the information of the first device, the link model pool comprising respective communication link models of the one or more edge nodes.

10. The method according to claim 1, further comprising:
determining a fault level of the first edge node according to at least one of a weight of the faulty device, service level information of the first edge node, or a fault duration; and
processing the faulty device according to the fault level of the first edge node.

11. The method according to claim 10, further comprising:
determining a quantity of second devices within the one or more second devices in the first communication link model that are incapable of normal operation;
determining a fault state model of the first edge node according to the link fault information, the quantity of the second devices, and service level information of the first edge node; and
determining at least one of a weight of the faulty device, the service level information, or a fault duration according to the fault state model.

12. An apparatus for fault processing, comprising processing circuitry configured to:
determine, based on a distributed cloud that includes a central node and one or more edge nodes, that a first device is incapable of normal operation, the first device being in a first edge node of the one or more edge nodes in the distributed cloud;
acquire a first communication link model of the first edge node, the first communication link model comprising a detection module in the central node, one or more second devices in the first edge node, and one or more third devices configured to transmit data between the detection module and the one or more second devices, the first communication link model indicating a communication link relationship among the detection module, the one or more second devices and the one or more third devices;
detect respective operation states of devices in the first communication link model; and
determine link fault information in association with the first communication link model, the link fault information comprising information of a faulty device in the first communication link model.

13. The apparatus according to claim 12, wherein the first communication link model comprises a tree structure that includes:
the detection module as a root node of the tree structure that records child nodes of the root node,
the one or more second devices as leaf nodes of the tree structure, and
the one or more third devices as intermediate nodes of the tree structure that record respective child nodes of the intermediate nodes.

14. The apparatus according to claim 13, wherein the processing circuitry is configured to:
traverse operation states of nodes in the tree structure from the root node corresponding to the detection module,
determine the faulty device in the first communication link model based on the operation states of the nodes; and
determine the link fault information according to the information of the faulty device.

15. The apparatus according to claim 14, wherein the processing circuitry is configured to:
detect whether a corresponding device to a current node in the tree structure is in normal operation; and
determine, when the current node is incapable of normal operation, the corresponding device to the current node as the faulty device.

16. The apparatus according to claim 15, wherein the processing circuitry is configured to:
detect, when a sibling node exists for the current node, whether a device corresponding to the sibling node is in normal operation.

17. The apparatus according to claim 15, wherein the processing circuitry is configured to:
detect, when the current node is in normal operation and a child node exists for the current node, whether a device corresponding to the child node of the current node is in normal operation.

18. The apparatus according to claim 12, wherein the processing circuitry is configured to:
acquire, from the detection module in the central node of the distributed cloud, information of the first device that is incapable of normal operation, the detection module being configured to acquire operation states of the central node and the devices in the first communication link model.

19. The apparatus according to claim 12, wherein the processing circuitry is configured to:
acquire, from a fault list, information of the first device that is incapable of normal operation, the fault list being configured for caching information of at least one device that is incapable of normal operation, the information of the at least one device being obtained from the detection module.

20. A non-transitory computer-readable storage medium storing instructions which when executed by at least one processor cause the at least one processor to perform:
determining, based on a distributed cloud that includes a central node and one or more edge nodes, that a first device is incapable of normal operation, the first device being in a first edge node in the one or more edge nodes of the distributed cloud;
acquiring a first communication link model of the first edge node, the first communication link model comprising a detection module in the central node, one or more second devices in the first edge node, and one or more third devices configured to transmit data between the detection module and the one or more second devices, the first communication link model indicating a communication link relationship among the detection module, the one or more second devices and the one or more third devices;
detecting respective operation states of devices in the first communication link model; and
determining link fault information in association with the first communication link model, the link fault information comprising information of a faulty device in the first communication link model.
